(19) United States
(12) Patent Application Publication
(10) Pub. No.: US 2026/0367472 A1
(43) Pub. Date: Nov. 19, 2026

(54) OPTICAL MODULE

(71) Applicant: Mitsubishi Electric Corporation, Tokyo (JP)

(72) Inventor: Junichi SUZUKI, Tokyo (JP)

(73) Assignee: Mitsubishi Electric Corporation, Tokyo (JP)

(21) Appl. No.: 19/731,729

(22) Filed: Jul. 6, 2026

Related U.S. Application Data
(63) Continuation of application No. PCT/JP2024/006408, filed on Feb. 22, 2024.

(51) Int. Cl. G02F 1/225; G02F 1/01

(52) U.S. Cl. CPC G02F 1/225; G02F 1/0147; G02F 2203/15; G02F 2203/21

(57) ABSTRACT

An optical module includes: a ring resonator having: a first waveguide section having a temperature-independent group refractive index, a second waveguide section having a negatively temperature-dependent group refractive index, and a third waveguide section having a positively temperature-dependent group refractive index; and a heater that heats either of the second waveguide section or the third waveguide section.

### CROSS REFERENCE TO RELATED APPLICATION

This application is a Continuation of PCT International Application No. PCT/JP2024/006408, filed on Feb. 22, 2024, which is hereby expressly incorporated by reference into the present application.

### TECHNICAL FIELD

The present disclosure relates to an optical module having a ring-resonator-type filter.

### BACKGROUND ART

As the capacity of optical communication systems increases, wavelength division multiplexing communication schemes have been used. Non-Patent Literature 1 discloses a ring resonator that achieves athermalization (temperature independence), which is one of wavelength filters required for a wavelength division multiplexing communication scheme.

The ring resonator disclosed in Non-Patent Literature 1 is a ring resonator to which the structure of a Si slot waveguide is applied.

The Si slot waveguide disclosed in Non-Patent Literature 1 is a slot waveguide on a Silicon On Insulator (SOI) substrate, in which a gap between a pair of silicon (Si) slot optical waveguides is filled with benzocyclobutene (benzocyclobutene: BCB).

### CITATION LIST

### Non-Patent Literatures

Non-Patent Literature 1: Yuki Atsumi, et. al., “Athermal wavelength property of Si-slot ring resonator embedded with benzocyclobutene” 2009 6th IEEE International Conference on Group IV Photonics, ThB3

### SUMMARY OF INVENTION

### Technical Problem

Since the refractive index of silicon included in the slot waveguide relative to a clad layer of silicon oxide (SiO₂) has positive temperature dependence, the ring resonator disclosed in Non-Patent Literature 1 achieves athermalization that cancels out the temperature dependence of light propagated through the slot waveguide by embedding BCB having a negatively temperature-dependent refractive index in the gap and adjusting the gap.

However, there is a problem with a wavelength filter using the ring resonator illustrated in Non-Patent Literature 1 that the optical phase state that determines the resonant peak wavelength of the filter cannot be accurately controlled during fabrication of the ring resonator, and since the waveguide is temperature-independent, thermal techniques that are widely used for phase adjustment relative to light cannot be applied.

The present disclosure solves the problem described above, and an object thereof is to achieve athermalization and obtain an optical module that is capable of easily adjusting the resonant peak wavelength of light propagating through a waveguide in a ring resonator.

### Solution to Problem

An optical module according to the present disclosure includes: a ring resonator having: a first waveguide section having a temperature-independent group refractive index, a second waveguide section having a negatively temperature-dependent group refractive index, and a third waveguide section having a positively temperature-dependent group refractive index; and a heater that heats either of the second waveguide section or the third waveguide section.

### Advantageous Effects of Invention

According to the present disclosure, since the ring resonator has the waveguide section having the temperature-independent group refractive index, the waveguide section having the negatively temperature-dependent group refractive index, and the waveguide section having the positively temperature-dependent group refractive index, and the heater that heats at least one of the waveguide section having the negatively temperature-dependent group refractive index or the waveguide section having the positively temperature-dependent group refractive index is provided, athermalization is achieved, and fine adjustment of the resonant peak wavelength in the ring resonator can be achieve with high precision and with ease.

### BRIEF DESCRIPTION OF DRAWINGS

FIG. 1 is a top view schematically illustrating a ring-resonator-type filter in an optical module according to a first embodiment.

FIG. 2 is a schematic cross-sectional view for explaining a slot waveguide in the optical module according to the first embodiment.

### DESCRIPTION OF EMBODIMENTS

### First Embodiment

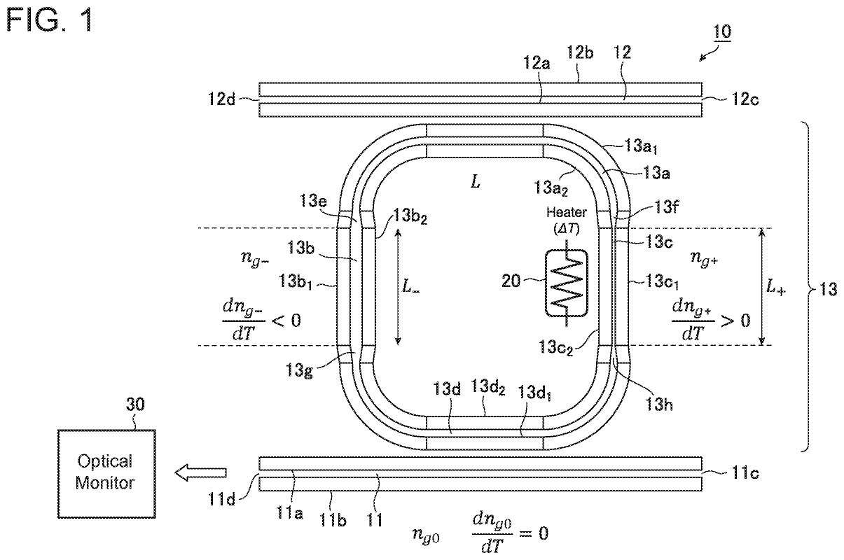

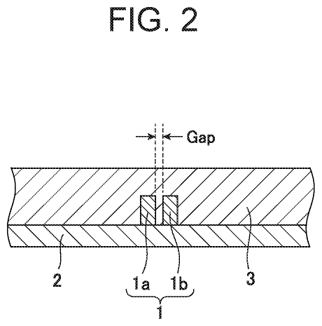

An optical module according to a first embodiment is explained using FIGS. 1 and 2.

The optical module according to the first embodiment is an optical module having a ring-resonator-type filter which is a wavelength filter.

The wavelength filter is used in an optical communication system employing a wavelength division multiplexing communication scheme.

In optical communication, the wavelength filter has the function of extracting only light of a required wavelength from light that has been wavelength-multiplexed during transmission and causing the light to carry a signal or the function of extracting light of a required wavelength from light that has been wavelength-multiplexed during reception and causing the light to enter a photoreceiver.

Accordingly, to obtain required light from wavelength-multiplexed light that combines light of many wavelengths, the wavelength filter is required to have steep filtering characteristics and accurate center wavelength setting.

A ring resonator in the ring-resonator-type filter constituting the wavelength filter outputs light having periodic wavelength dependence with resonance peak values at wavelengths that form stationary waves in the ring resonator.

The ring-resonator-type filter in the optical module according to the first embodiment can achieve athermalization (temperature independence) and can achieve fine adjustment of the resonant peak wavelength with high precision and with ease.

Note that, other than a wavelength filter that extracts light of a required wavelength from wavelength-multiplexed light, the ring-resonator-type filter can also be used as a filter that monitors the wavelength of a semiconductor laser that performs single-mode oscillation or as an external resonator mirror with a filter function for laser oscillation in combination with a semiconductor optical amplifier.

As illustrated in FIG. 1, the optical module according to the first embodiment basically includes a ring-resonator-type filter 10 and a heater 20.

The ring-resonator-type filter 10 includes a first bus waveguide 11, a second bus waveguide 12, and a ring resonator 13.

Note that it is assumed in the following explanation that the first bus waveguide 11 is an input optical waveguide where wavelength-multiplexed light is incident, and the incident light is propagated, and the second bus waveguide 12 is an output optical waveguide where light having periodic wavelength dependence with resonance peak values at wavelengths that form stationary waves in the ring resonator 13 is incident, guided, and output.

Initially, a slot waveguide included in each of the first bus waveguide 11, the second bus waveguide 12, and the ring resonator 13 is explained using FIG. 2.

A slot waveguide 1 includes a pair of optical waveguides 1a and 1b that are arranged on a surface of a SOI substrate proximately parallel to each other with a gap Gap and have narrow widths. The optical waveguides 1a and 1b are formed using a known technology.

FIG. 2 illustrates a silicon oxide layer (SiO₂) 2 which is a surface layer of the SOI substrate, and the silicon oxide layer 2 functions as a lower cladding for the optical waveguides 1a and 1b.

An insulation layer 3 is formed on the surface of the SOI substrate, embedding the slot waveguide 1 and including benzocyclobutene (hereinbelow, referred to BCB) to fill the gap Gap between the pair of optical waveguides 1a and 1b. The insulation layer 3 is formed using a known technology.

The insulation layer 3 functions as an upper cladding for the optical waveguides 1a and 1b.

The refractive index of silicon forming the optical waveguides 1a and 1b is higher than the refractive index of silicon oxide forming the silicon oxide layer 2 and increases as temperature rises.

The refractive index of BCB forming the insulation layer 3 decreases as temperature rises.

That is, the gap Gap between the optical waveguides 1a and 1b using silicon having positive temperature dependence (temperature coefficient) is filled with negatively temperature-dependent BCB, and the temperature dependence of light propagating through the optical waveguides 1a and 1b is cancelled out.

Accordingly, using variations of the confinement factor of light having entered the BCB 3 caused by variations of the width of the gap Gap between the optical waveguides 1a and 1b, it is possible to set the group-refractive-index temperature dependence at the section of the slot waveguide 1 including BCB to be temperature-independent, negatively temperature-dependent, or positively temperature-dependent.

Note that it is sufficient if the material forming the optical waveguides 1a and 1b is a material whose refractive index increases as temperature rises, and, other than silicon, silicon nitride (SiN), indium phosphide (InP), or the like may be used.

In addition, the material of the lower cladding (silicon oxide layer) 2 is not limited to silicon oxide, and it is sufficient if the material is a material whose refractive index is lower than the material forming the optical waveguides 1a and 1b.

It is sufficient if the material forming the upper cladding (insulation layer) 3 is a material whose refractive index decreases as temperature rises, and, other than BCB, titanium oxide (TiO₂) or the like may be used.

On the surface of the silicon oxide layer 2, the input optical waveguide 11 has: a pair of optical waveguides 11a and 11b that are disposed parallel to each other and linearly with the gap Gap having the same width over the entire lengths; and the insulation layer 3 filling the gap Gap between the optical waveguides 11a and 11b. The input optical waveguide 11 has the structure with the cross-sectional shape illustrated in FIG. 2.

The gap Gap between the optical waveguides 11a and 11b of the input optical waveguide 11 is set in such a manner that the group-refractive-index temperature dependence is temperature-independent.

That is, assuming that the group refractive index of the input optical waveguide 11 is n_{g1}, the gap Gap between the optical waveguides 11a and 11b is set in such a manner that the group-refractive-index temperature dependence of the input optical waveguide 11 is 0 as represented by Formula (1) below.

dn_{g1}/dT=0 (1)

In Formula (1) above, Tis temperature.

The input optical waveguide 11 has an end having a first port 11c and another end having a second port 11d.

Note that it is assumed in the following explanation that the first port 11c is an optical input port where wavelength-multiplexed light is incident, and the second port 11d is a through port.

The through port 11d of the input optical waveguide 11 is connected to an optical monitor 30 via a light receiving element (not illustrated).

In addition, the optical monitor 30 has a function to, depending on the output level of a light receiving element having sensed light from the through port 11d of the input optical waveguide 11, observe (monitor) light from the through port 11d and adjust the amount of heating by the heater 20.

The output optical waveguide 12 is disposed parallel to the input optical waveguide 11 with the ring resonator 13 being interposed therebetween.

On the surface of the silicon oxide layer 2, the output optical waveguide 12 has: a pair of optical waveguides 12a and 12b that are disposed parallel to each other and linearly with the gap Gap having the same width over the entire lengths; and the insulation layer 3 filling the gap Gap between the optical waveguides 12a and 12b. The output optical waveguide 12 has the structure with the cross-sectional shape illustrated in FIG. 2.

The gap Gap between the optical waveguides 12a and 12b of the output optical waveguide 12 is set in such a manner that the group-refractive-index temperature dependence is temperature-independent.

That is, assuming that the group refractive index of the output optical waveguide 12 is n_{g1}, the gap Gap between the optical waveguides 12a and 12b is set in such a manner that the group-refractive-index temperature dependence of the output optical waveguide 12 is 0 as represented by Formula (2) below.

dn_{g1}/dT=0 (2)

The output optical waveguide 12 has an end having a first port 12c and another end having a second port 12d.

Note that it is assumed in the following explanation that the first port 12c is an optical output port where light in a wavelength band resonated by the ring resonator 13 is emitted.

The ring resonator 13 has a first waveguide section 13a, a second waveguide section 13b, a third waveguide section 13c, a fourth waveguide section 13d, and connecting waveguide sections 13e to 13h.

The first waveguide section 13a and the second waveguide section 13b are connected to the connecting waveguide section 13e. The first waveguide section 13a and the third waveguide section 13c are connected to the connecting waveguide section 13f. The fourth waveguide section 13d and the second waveguide section 13b are connected to the connecting waveguide section 13g. The fourth waveguide section 13d and the third waveguide section 13c are connected to the connecting waveguide section 13h.

As a result, the first waveguide section 13a to the fourth waveguide section 13d are connected by the connecting waveguide sections 13e to 13h, thereby forming a seamless ring-shaped optical waveguide.

Note that there are no physical boundaries between the waveguide sections and the connecting waveguide sections, but there are simply virtual boundary planes.

In addition, the seamless ring-shaped optical waveguide included in the ring resonator 13 is referred to as a ring-shaped optical waveguide in the following explanation.

The first waveguide section 13a is disposed facing the output optical waveguide 12.

On the surface of the silicon oxide layer 2, the first waveguide section 13a has: a slot waveguide including a pair of optical waveguides 13a1 and 13a2 that are disposed parallel to each other with the gap Gap having the same width over the entire lengths; and an insulation layer filling the gap Gap between the optical waveguides 13a1 and 13a2. The first waveguide section 13a has the structure with the cross-sectional shape illustrated in FIG. 2.

The first waveguide section 13a has, in its planar shape: a first arc section at an end thereof; a second arc section at the other end thereof; and a straight section between the first arc section and the second arc section. The straight section is disposed parallel to the output optical waveguide 12.

The gap Gap between the optical waveguides 13a1 and 13a2 of the first waveguide section 13a is set in such a manner that the group-refractive-index temperature dependence is temperature-independent.

That is, assuming that the group refractive index of the first waveguide section 13a is n_{g0}, the gap Gap between the optical waveguides 13a1 and 13a2 is set in such a manner that the group-refractive-index temperature dependence of the first waveguide section 13a is 0 as represented by Formula (3) below.

dn_{g0}/dT=0 (3)

In summary, the group-refractive-index temperature dependence of the first waveguide section 13a is set to be temperature-independent.

The fourth waveguide section 13d is disposed at a position opposite to the first waveguide section 13a in the ring-shaped optical waveguide and is disposed facing the input optical waveguide 11.

On the surface of the silicon oxide layer 2, the fourth waveguide section 13d has: a slot waveguide including a pair of optical waveguides 13d₁ and 13d₂ that are disposed parallel to each other with the gap Gap having the same width over the entire lengths; and an insulation layer filling the gap Gap between the optical waveguides 13d₁ and 13d₂. The fourth waveguide section 13d has the structure with the cross-sectional shape illustrated in FIG. 2.

The fourth waveguide section 13d has, in its planar shape: a first arc section at an end thereof; a second arc section at the other end thereof; and a straight section between the first arc section and the second arc section. The straight section is disposed parallel to the input optical waveguide 11.

The gap Gap between the optical waveguides 13d₁ and 13d₂ of the fourth waveguide section 13d is set in such a manner that the group-refractive-index temperature dependence is temperature-independent.

That is, assuming that the group refractive index of the fourth waveguide section 13d is n_{g0}, the gap Gap between the optical waveguides 13d₁ and 13d₂ is set in such a manner that the group-refractive-index temperature dependence of the fourth waveguide section 13d is 0 as represented by Formula (4) below.

dn_{g0}/dT=0 (4)

In summary, the group-refractive-index temperature dependence of the fourth waveguide section 13d is set to be temperature-independent.

The second waveguide section 13b is disposed between an end of the first waveguide section 13a and an end of the fourth waveguide section 13d.

On the surface of the silicon oxide layer 2, the second waveguide section 13b has: a slot waveguide including a pair of optical waveguides 13b₁ and 13b₂ that are disposed parallel to each other and linearly with the gap Gap having the same width over the entire lengths; and an insulation layer filling the gap Gap between the optical waveguides 13b₁ and 13b₂. The second waveguide section 13b has the structure with the cross-sectional shape illustrated in FIG. 2.

The width of the gap Gap between the optical waveguides 13b₁ and 13b₂ is set wider than the width of the gap Gap between the optical waveguides 13a1 and 13a2 in the first waveguide section 13a and the width of the gap Gap between the optical waveguides 13d₁ and 13d₂ in the fourth waveguide section 13d.

As a result, the second waveguide section 13b has a negatively temperature-dependent group refractive index.

That is, assuming that the group refractive index of the second waveguide section 13b is n_{g-}, the gap Gap between the optical waveguides 13b₁ and 13b₂ is set in such a manner that the group-refractive-index temperature dependence of the second waveguide section 13b is smaller than 0 as represented by Formula (5) below.

dn_{g-}/dT<0 (5)

The connecting waveguide section 13e connecting the first waveguide section 13a and the second waveguide section 13b has a taper structure having width that adiabatically widens toward the second waveguide section 13b.

The connecting waveguide section 13e has: a slot waveguide including a pair of optical waveguides; and an insulation layer filling the gap Gap between the pair of optical waveguides. The connecting waveguide section 13e has the structure with the cross-sectional shape illustrated in FIG. 2.

The width of the gap Gap between the pair of optical waveguides in the connecting waveguide section 13e widens from the width of the gap Gap between the optical waveguides 13a1 and 13a2 in the first waveguide section 13a to the width of the gap Gap between the optical waveguides 13b₁ and 13b₂ in the second waveguide section 13b, and the pair of optical waveguides in the connecting waveguide section 13e is disposed in a tapered manner, widening toward the second waveguide section 13b.

Since the first waveguide section 13a and the second waveguide section 13b are connected by the taper structure of the connecting waveguide section 13e with the adiabatically widening width, there are no reflection points in the connecting waveguide section 13e, and reflection of light does not occur in the connecting waveguide section 13e during the propagation of light through the ring-shaped optical waveguide.

The connecting waveguide section 13g connecting the fourth waveguide section 13d and the second waveguide section 13b has a taper structure having width that adiabatically widens toward the second waveguide section 13b.

The connecting waveguide section 13g has: a slot waveguide including a pair of optical waveguides; and an insulation layer filling the gap Gap between the pair of optical waveguides. The connecting waveguide section 13g has the structure with the cross-sectional shape illustrated in FIG. 2.

The width of the gap Gap between the pair of optical waveguides in the connecting waveguide section 13g widens from the width of the gap Gap between the optical waveguides 13d₁ and 13d₂ in the fourth waveguide section 13d to the width of the gap Gap between the optical waveguides 13b₁ and 13b₂ in the second waveguide section 13b, and the pair of optical waveguides in the connecting waveguide section 13g is disposed in a tapered manner, widening toward the second waveguide section 13b.

Since the fourth waveguide section 13d and the second waveguide section 13b are connected by the taper structure of the connecting waveguide section 13g with the adiabatically widening width, there are no reflection points in the connecting waveguide section 13g, and reflection of light does not occur in the connecting waveguide section 13g during the propagation of light through the ring-shaped optical waveguide.

The third waveguide section 13c is disposed between the other end of the first waveguide section 13a and the other end of the fourth waveguide section 13d.

On the surface of the silicon oxide layer 2, the third waveguide section 13c has: a slot waveguide including a pair of optical waveguides 13c1 and 13c2 that are disposed parallel to each other and linearly with the gap Gap having the same width over the entire lengths; and an insulation layer filling the gap Gap between the optical waveguides 13c1 and 13c2. The third waveguide section 13c has the structure with the cross-sectional shape illustrated in FIG. 2.

The width of the gap Gap between the optical waveguides 13c1 and 13c2 is set narrower than the width of the gap Gap between the optical waveguides 13a1 and 13a2 in the first waveguide section 13a and the width of the gap Gap between the optical waveguides 13d₁ and 13d₂ in the fourth waveguide section 13d.

As a result, the third waveguide section 13c has a positively temperature-dependent group refractive index.

That is, assuming that the group refractive index of the third waveguide section 13c is n_{g+}, the gap Gap between the optical waveguides 13c1 and 13c2 is set in such a manner that the group-refractive-index temperature dependence of the third waveguide section 13c is greater than 0 as represented by Formula (6) below.

dn_{g+}/dT>0 (6)

The connecting waveguide section 13f connecting the first waveguide section 13a and the third waveguide section 13c has a taper structure having width that adiabatically narrows toward the third waveguide section 13c.

The connecting waveguide section 13f has: a slot waveguide including a pair of optical waveguides; and an insulation layer filling the gap Gap between the pair of optical waveguides. The connecting waveguide section 13f has the structure with the cross-sectional shape illustrated in FIG. 2.

The width of the gap Gap between the pair of optical waveguides in the connecting waveguide section 13f narrows from the width of the gap Gap between the optical waveguides 13a₁ and 13a₂ in the first waveguide section 13a to the width of the gap Gap between the optical waveguides 13c₁ and 13c₂ in the third waveguide section 13c, and the pair of optical waveguides in the connecting waveguide section 13f is disposed in a tapered manner, narrowing toward the third waveguide section 13c.

Since the first waveguide section 13a and the third waveguide section 13c are connected by the taper structure of the connecting waveguide section 13f with the adiabatically narrowing width, there are no reflection points in the connecting waveguide section 13f, and reflection of light does not occur in the connecting waveguide section 13f during the propagation of light through the ring-shaped optical waveguide.

The connecting waveguide section 13h connecting the fourth waveguide section 13d and the third waveguide section 13c has a taper structure having width that adiabatically narrows toward the third waveguide section 13c.

The connecting waveguide section 13h has: a slot waveguide including a pair of optical waveguides; and an insulation layer filling the gap Gap between the pair of optical waveguides. The connecting waveguide section 13h has the structure with the cross-sectional shape illustrated in FIG. 2.

The width of the gap Gap between the pair of optical waveguides in the connecting waveguide section 13h narrows from the width of the gap Gap between the optical waveguides 13d₁ and 13d₂ in the fourth waveguide section 13d toward the width of the gap Gap between the optical waveguides 13c1 and 13c2 in the third waveguide section 13c, and the pair of optical waveguides in the connecting waveguide section 13h is disposed in a tapered manner, narrowing toward the third waveguide section 13c.

Since the fourth waveguide section 13d and the third waveguide section 13c are connected by the taper structure of the connecting waveguide section 13h with the adiabatically narrowing width, there are no reflection points in the connecting waveguide section 13h, and reflection of light does not occur in the connecting waveguide section 13h during the propagation of light through the ring-shaped optical waveguide.

In the ring resonator 13, the length L. of the second waveguide section 13b and the length L₊ of the third waveguide section 13c are set as follows in such a manner that the group refractive index of the ring-shaped optical waveguide as a whole (one loop of the ring) is temperature-independent, that is, the temperature dependence does not manifest over the one loop of the ring.

Note that it is assumed that the sum of the length of the first waveguide section 13a and the length of the fourth waveguide section 13d is L.

The resonant wavelength m·λ of the ring resonator 13 can be represented by Formula (7) below.

n_{g0}L+n_{g+}L₊+n_{g-}L₋=m·λ (7)

By differentiating Formula (7) above with respect to temperature, Formula (8) below is obtained.

$$\frac{d}{dT} ( {n}_{g 0} L + {n}_{g +} {L}_{+} + {n}_{g -} {L}_{-} ) = \frac{d}{dT} ( m \cdot λ ) \qquad ( 8 )$$

By setting the right-hand side of Formula (8) above to 0, the group-refractive-index temperature dependence of the ring-shaped optical waveguide as a whole is temperature-independent. At this time, it is assumed that the physical lengths L, L₊, and L₋ do not change depending on temperature.

The case where the right-hand side of Formula (8) above is set to 0 is represented by Formula (9) below.

$$\frac{{dn}_{g 0}}{dT} L + \frac{{dn}_{g +}}{d T} {L}_{+} + \frac{{dn}_{g -}}{dT} {L}_{-} = 0 \qquad ( 9 )$$

Since the group refractive indices of the first waveguide section 13a and the fourth waveguide section 13d are set to be temperature-independent, Formula (9) above can be represented by Formula (10) below.

$$\frac{{dn}_{g +}}{dT} {L}_{+} + \frac{{dn}_{g -}}{dT} {L}_{-} = 0 \qquad ( 10 )$$

By setting the length L. of the second waveguide section 13b and the length L₊ of the third waveguide section 13c in such a manner that Formula (10) above is satisfied, the group-refractive-index temperature dependence of the ring resonator 13 is temperature-independent.

That is, the length L₋ of the second waveguide section 13b and the length L₊ of the third waveguide section 13c are set to such lengths that the sum of the product of the group-refractive-index temperature dependence value dn_{g-}/dT and length L₋ of the second waveguide section 13b and the product of the group-refractive-index temperature dependence value dn_{g+}/dT and length L₊ of the third waveguide section 13c is 0.

The heater 20 is disposed on the inner side of the ring-shaped optical waveguide and adjacent to the third waveguide section 13c in order to heat the third waveguide section 13c.

The heater 20 is embedded in the insulation layer 3.

The heater 20 has the effect of lengthening the optical path length of the one loop of the ring of the ring-shaped optical waveguide by heating the third waveguide section 13c, and is capable of modifying, that is, finely adjusting, the peak wavelength, that is, resonant wavelength, of the ring resonator 13.

Note that the heater 20 may be disposed on the outer side of or at the top of the ring-shaped optical waveguide.

In addition, the heater 20 may be disposed on the inner side, on the outer side, or at the top of the ring-shaped optical waveguide and adjacent to the second waveguide section 13b in order to heat the second waveguide section 13b.

The heater 20 has the effect of shortening the optical path length of the one loop of the ring of the ring-shaped optical waveguide by heating the second waveguide section 13b, and is capable of modifying, that is, finely adjusting, the peak wavelength, that is, resonant wavelength, of the ring resonator 13.

Furthermore, the heater 20 may be disposed adjacent to each of the third waveguide section 13c and the second waveguide section 13b in order to heat each of the third waveguide section 13c and the second waveguide section 13b.

By disposing the heater adjacent to each of the third waveguide section 13c and the second waveguide section 13b and selecting either of the heaters to heat the third waveguide section 13c or the second waveguide section 13b, it is possible to achieve the effect of lengthening or shortening the optical path length of the one loop of the ring of the ring-shaped optical waveguide, and it is possible to make a modification to lengthen or shorten the peak wavelength, that is, resonant wavelength, of the ring resonator 13, that is, to make a fine adjustment to either lengthen or shorten the peak wavelength of the ring resonator 13.

Next, an operation related to a fine adjustment of the peak wavelength, that is, resonant wavelength, of the ring resonator 13 whose group-refractive-index temperature dependence is set to be temperature-independent in the optical module according to the first embodiment is explained.

Here, as a premise, it is assumed that, in the ring-resonator-type filter 10, light is caused to be incident on the optical input port 11c of the input optical waveguide 11, and light is output from the optical output port 12c of the output optical waveguide 12.

When the wavelength of light to be incident on the optical input port 11c of the input optical waveguide 11 is changed, and the light is caused to be incident thereon or wavelength-multiplexed light is caused to be incident thereon, light having periodic wavelength dependence with resonance peaks at wavelengths that form stationary waves in the ring resonator 13 is output from the optical output port 12c of the output optical waveguide 12.

First, the point that the resonant wavelength m·λ of the ring resonator 13 can be modified by causing the heater 20 to heat the third waveguide section 13c is explained.

In a state where the third waveguide section 13c is not being heated by the heater 20, the resonant wavelength m. 2 of the ring resonator 13 when the ambient temperature has changed is assumed to be given by Formula (11) below.

That is, the resonant wavelength m·λ assumed to be affected by a temperature change ΔT is represented by Formula (11) below.

In Formula (11) below, the second terms in the three parentheses on the left-hand side represent the effect of the temperature change ΔT.

$$( {n}_{g 0} {\vert}_{T = 0} + \frac{{dn}_{g 0}}{dT} Δ T ) \cdot L + ( {n}_{g +} {\vert}_{T = 0} + \frac{{dn}_{g +}}{dT} Δ T ) \cdot {L}_{+} + ( {n}_{g -} {\vert}_{T = 0} + \frac{{dn}_{g -}}{dT} Δ T ) \cdot {L}_{-} m \cdot λ \qquad ( 11 )$$

Formula (11) above can be transformed into Formula (12) below.

$$( {n}_{g 0} {\vert}_{T = 0} \cdot L + {n}_{g +} {\vert}_{T = 0} \cdot {L}_{+} + {n}_{g -} {\vert}_{T = 0} \cdot {L}_{-} ) + ( \frac{{dn}_{g 0}}{dT} \cdot L + \frac{{dn}_{g +}}{dT} \cdot {L}_{+} + \frac{{dn}_{g -}}{dT} \cdot {L}_{-} ) Δ T = m \cdot λ \qquad ( 12 )$$

In the first embodiment, since the group-refractive-index temperature dependence of the ring resonator 13 is set to be temperature-independent, and the inside of the parentheses in the second term on the left-hand side in Formula (12) above is 0, Formula (12) above can be represented by Formula (13) below.

(n_{g0}|_{T=0}·L+n_{g+}|_{T=0}·L₊+n_{g-}|_{T=0}·L₋)+0·ΔT=m·λ (13)

On the other hand, in a state where the ambient temperature has changed by ΔT, the resonant wavelength m′·λ of the ring resonator 13 in a state where the third waveguide section 13c is heated by the heater 20 to raise the ambient temperature (surrounding temperature) of the third waveguide section 13c by T′, is assumed to be given by Formula (14) below.

$$( {n}_{g 0} {\vert}_{T = 0} + \frac{{dn}_{g 0}}{dT} Δ T ) \cdot L + ( {n}_{g +} {\vert}_{T = 0} + \frac{{dn}_{g +}}{dT} ( Δ T + {T}^{′} ) ) \cdot {L}_{+} + ( {n}_{g -} {\vert}_{T = 0} + \frac{{dn}_{g -}}{dT} Δ T ) \cdot {L}_{-} = {m}^{′} \cdot λ \qquad ( 14 )$$

Formula (14) above corresponds to Formula (11) above which is assumed to be followed in a case where the ambient temperature has risen by ΔT, and represents the resonant wavelength m′·λ of the ring resonator 13 in a case where only the ambient temperature of the third waveguide section 13c has further risen by T′.

Formula (15) below is obtained by transforming Formula (14) above similarly to the transformation of Formula (11) above into Formula (12) above and further processing Formula (14) above similarly to the process of setting the inside of the parentheses of the second term on the left-hand side in Formula (12) above to 0 since the group-refractive-index temperature dependence of the ring resonator 13 is set to be temperature-independent in the first embodiment.

Formula (15) below corresponds to Formula (13) above.

$$( {n}_{g 0} {\vert}_{T = 0} \cdot L + {n}_{g +} {\vert}_{T = 0} \cdot {L}_{+} + {n}_{g -} {\vert}_{T = 0} \cdot {L}_{-} ) + \frac{{dn}_{g +}}{dT} {T}^{′} \cdot {L}_{+} + 0 \cdot Δ T = {m}^{′} \cdot λ \qquad ( 15 )$$

Formula (15) above can be represented by Formula (16) below.

$$( {n}_{g 0} {\vert}_{T = 0} \cdot L + {n}_{g +} {\vert}_{T = 0} \cdot {L}_{+} + {n}_{g -} {\vert}_{T = 0} \cdot {L}_{-} ) + \frac{{dn}_{g +}}{dT} {T}^{′} \cdot {L}_{+} = {m}^{′} \cdot λ \qquad ( 16 )$$

m′ in Formula (16) above is a value greater than m in Formula (13) above, and this means that, by causing the heater 20 to heat the third waveguide section 13c, the resonant wavelength m′·λ of the ring resonator 13 can be modified from the resonant wavelength m′·λ of the ring resonator 13 in a case where the third waveguide section 13c is not heated.

That is, when a temperature gradient is created between the third waveguide section 13c and the second waveguide section 13b by heating the third waveguide section 13c and not heating the second waveguide section 13b, the phase of light in the ring resonator 13 can be changed, and the resonant wavelength of the ring resonator 13 can be modified.

In summary, it is possible to achieve the ring resonator 13 whose resonant wavelength mλ does not change, even when the ambient temperature has changed and the overall temperature of the ring resonator 13, in particular the temperature of the third waveguide section 13c and the temperature of the second waveguide section 13b, has changed by the same temperature. That is, it is possible to achieve the ring resonator 13 having a temperature-independent group refractive index. On the basis of this, by creating a temperature gradient between the third waveguide section 13c and the second waveguide section 13b using the heater 20, the resonant wavelength of the ring resonator 13 can be finely adjusted.

On the basis of the content described above, the operation for fine adjustment of the resonant wavelength of the ring resonator 13 whose group-refractive-index temperature dependence is set to be temperature-independent is explained.

In response to light incident from the optical input port 11c of the input optical waveguide 11, light of a wavelength based on the resonant frequency of the ring resonator 13 is output from the optical output port 12c of the output optical waveguide 12.

On the other hand, the optical monitor 30 observing (monitoring) light from the through port 11d of the input optical waveguide 11 determines that the resonant frequency of the ring resonator 13 has deviated from a set resonant frequency when the intensity of light from the through port 11d, such as the output level of a light receiving element having sensed the light from the through port 11d of the input optical waveguide 11, is high, and controls the amount of heating by the heater 20 via a heater control circuit (not illustrated).

The heater 20 whose amount of heating is controlled heats the third waveguide section 13c, and the resonant wavelength of the ring resonator 13 is modified, that is, finely adjusted, as illustrated in Formula (16) above. When the resonant wavelength of the ring resonator 13 is finely adjusted to the set resonant frequency, and the output level of the light receiving element having sensed the light from the through port 11d of the input optical waveguide 11 has lowered, it is determined that light of the set wavelength is being output from the optical output port 12c of the output optical waveguide 12, and the heating of the third waveguide section 13c by the heater 20 is stopped.

Note that, whereas the optical monitor 30 observes light from the through port 11d of the input optical waveguide 11 in the first embodiment, light output from the optical output port 12c of the output optical waveguide 12 may be observed to control the amount of heating by the heater 20 via the heater control circuit. In this case, when the intensity of light of the resonant wavelength output from the optical output port 12c of the output optical waveguide 12 is low, the amount of heating by the heater 20 is controlled.

Accordingly, the ring-resonator-type filter 10 in the optical module according to the first embodiment is independent of ambient temperature changes, and the resonant wavelength of the ring resonator 13 can be finely adjusted by a control signal based on monitoring of light by the optical monitor 30.

Since the optical module according to the first embodiment includes: the ring resonator 13 having the first waveguide section 13a having a temperature-independent group refractive index, the second waveguide section 13b having a negatively temperature-dependent group refractive index, and the third waveguide section 13c having a positively temperature-dependent group refractive index; and the heater that heats either of the second waveguide section 13b or the third waveguide section 13c, the ring resonator 13 that is independent of ambient temperature changes and has a temperature-independent group refractive index can be achieved; moreover, the resonant wavelength of the ring resonator 13 can be finely adjusted with high precision and with ease.

Note that, whereas the first bus waveguide 11 is the input optical waveguide 11, the first port 11c is the optical input port, and the second port 11d is the through port in the first bus waveguide 11, the second bus waveguide 12 is the output optical waveguide 12, and the first port 12c is the optical output port in the second bus waveguide 12 in the first embodiment, this may be changed as follows.

The second bus waveguide 12 may be an input optical waveguide 12, the first port 12c may be an optical input port, and the second port 12d may be a through port in the second bus waveguide 12, the first bus waveguide 11 may be an output optical waveguide 11, and the second port 11d may be an optical output port in the first bus waveguide 11.

Each of the first port 11c of the first bus waveguide 11 and the first port 12c of the second bus waveguide 12 may be an optical input port, and each of the second port 11d of the first bus waveguide 11 and the second port 12d of the second bus waveguide 12 may be an optical output port.

In the first embodiment, for example, the configuration of the ring resonator 13 is a planar waveguide system on a silicon platform.

In addition, the ring-resonator-type filter 10 including the first bus waveguide 11, the second bus waveguide 12, and the ring resonator 13 is optically connected by a directional coupler, a Multi-Mode Interferometer (MMI), or the like. The filter characteristics of the ring resonator can be modified by changing the coupling coefficient at the optical connection portion and the circumference of the ring.

Whereas the ring resonator 13 uses the ring-shaped optical waveguide using the slot waveguide including the pair of optical waveguides in the first embodiment, by varying the width of the waveguide structure, the ring resonator 13 may use a ring-shaped optical waveguide having the first waveguide section 13a having a temperature-independent group refractive index, the second waveguide section 13b having a negatively temperature-dependent group refractive index, the third waveguide section 13c having a positively temperature-dependent group refractive index, and the fourth waveguide section 13d having a temperature-independent group refractive index.

Note that any combinations of embodiments, modifications of any components in embodiments, or omissions of any components in embodiments are possible.

### INDUSTRIAL APPLICABILITY

The optical module according to the present disclosure is suited for an optical module having a wavelength filter used for an optical communication system employing a wavelength division multiplexing communication scheme.

### REFERENCE SIGNS LIST

10: ring-resonator-type filter; 11: first bus waveguide (input optical waveguide); 12: second bus waveguide (output optical waveguide); 13: ring resonator; 13a: first waveguide section; 13a₁, 13a₂: optical waveguide; 13b: second waveguide section; 13b₁, 13b₂: optical waveguide; 13c: third waveguide section; 13c₁, 13c₂: optical waveguide; 13d: fourth waveguide section; 13d₁, 13d₂: optical waveguide; 13e to 13h: connecting waveguide section; 20: heater

1. An optical module comprising:
a ring resonator having: a first waveguide section having a temperature-independent group refractive index, a second waveguide section having a negatively temperature-dependent group refractive index, and a third waveguide section having a positively temperature-dependent group refractive index; and
a heater that heats either of the second waveguide section or the third waveguide section.

2. The optical module according to claim 1, wherein each of the first waveguide section, the second waveguide section, and the third waveguide section has: a slot waveguide including a pair of optical waveguides that are disposed parallel to each other with a gap on a surface of an SOI substrate and are formed using a material such as silicon, silicon nitride, or indium phosphide whose refractive index increases as temperature rises; and an insulation layer formed using a material, such as benzocyclobutene or titanium oxide whose refractive index decreases as temperature rises, the insulation layer being embedded in the gap between the pair of optical waveguides in the slot waveguide.

3. The optical module according to claim 1, wherein a length of the second waveguide section and a length of the third waveguide section are set in such a manner that a sum of a product of a group-refractive-index temperature dependence value of the second waveguide section and the length of the second waveguide section and a product of a group-refractive-index temperature dependence value of the third waveguide section and the length of the third waveguide section is 0.

4. The optical module according to claim 2, wherein a length of the second waveguide section and a length of the third waveguide section are set in such a manner that a sum of a product of a group-refractive-index temperature dependence value of the second waveguide section and the length of the second waveguide section and a product of a group-refractive-index temperature dependence value of the third waveguide section and the length of the third waveguide section is 0.

5. The optical module according to claim 3, wherein
the first waveguide section and the second waveguide section are connected by a connecting waveguide section with a taper structure having width that adiabatically widens toward the second waveguide section, and
the first waveguide section and the third waveguide section are connected by a connecting waveguide section with a taper structure having width that adiabatically narrows toward the third waveguide section.

6. The optical module according to claim 4, wherein
the first waveguide section and the second waveguide section are connected by a connecting waveguide section with a taper structure having width that adiabatically widens toward the second waveguide section, and
the first waveguide section and the third waveguide section are connected by a connecting waveguide section with a taper structure having width that adiabatically narrows toward the third waveguide section.
